(19) United States
(12) Patent Application Publication
(10) Pub. No.: US 2006/0290900 A1
(43) Pub. Date: Dec. 28, 2006

(54) PROJECTOR AND COLOR FILTERING DEVICE THEREOF

(75) Inventor: Ying-Fang Lin, Taoyuan County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/425,218

(22) Filed: Jun. 20, 2006

(30) Foreign Application Priority Data
Jun. 22, 2005 (TW) 94120836

(51) Int. Cl. G03B 21/14

(52) U.S. Cl. 353/84

(57) ABSTRACT

A projector includes a light source, a color filtering device, an optical assembly, an imaging component and a lens. The light source is used for generating light beams. The color filtering device includes a body and several color filter areas. The body has a longitudinal axis and a lateral axis. The body is reciprocated along the longitudinal axis. The color filter areas having different colors are sequentially arranged along the longitudinal axis on the body and used for filtering device light beams. The light beams pass through the color filter areas sequentially and present the corresponding colors of the passed color filter areas. The optical assembly receives the light beams passing through the color filtering device. The imaging component receives the light beams from the optical assembly and generates an image. The lens forms the image on a screen.

This application claims the benefit of Taiwan application Ser. No. 94120836, filed Jun. 22, 2005, the subject matter of which is incorporated herein by reference.

### BACKGROUND OF THE INVENTION

1. Field of the Invention

The invention relates in general to a projector and a color filtering device thereof, and more particularly to a color filtering device having a rectangular body and a projector using the same.

2. Description of the Related Art

A conventional projector uses a round color wheel to filter light beams emitted by the light source so as to project light beams with different colors onto the imaging component and further generate a true color image. During manufacturing the color wheel, one piece of big rectangular glass should be cut into several pieces of small round glass. In the subsequent manufacturing process, several pieces of small round glass are produced into several color wheels.

A rectangle fails to be completely divided into several circles. Therefore, during the conventional manufacturing process of the round color wheel, a lot of glass has to be cut off and wasted when one piece of big rectangular glass is cut into several pieces of small round glass. Since the glass is expensive, cutting off a lot of glass is wasteful and results in an increase of the manufacturing cost of the color wheel.

### SUMMARY OF THE INVENTION

It is therefore an object of the invention to provide a projector and a color filtering device thereof. During manufacturing the color filtering device, the utility rate of the glass can be enhanced by cutting the rectangular glass into the rectangular body of the color filtering device. Therefore, the cost for manufacturing the glass is reduced.

The invention achieves the above-identified object by providing a color filtering device, including a rectangular body and several color filter areas. The rectangular body has a longitudinal axis and a lateral axis and is reciprocated along the longitudinal axis. The color filter areas having different colors are sequentially arranged along the longitudinal axis on the rectangular body for filtering light beams. The light beams pass through the color filter areas sequentially and present the corresponding colors of the passed color filter areas.

The invention achieves the above-identified object by further providing a projector, including a light source, a color filtering device, an optical assembly, an imaging component, and a project lens. The light source is for emitting light beams. The color filtering device includes a body and several color filter areas. The rectangular body has a longitudinal axis and a lateral axis, and the body is reciprocated along the longitudinal axis. The color filter areas having different colors are sequentially arranged along the longitudinal axis on the body for filtering light beams. The light beams pass the color filter areas sequentially and then present the corresponding colors of the passed color filter areas. The optical assembly is for receiving the light beams passing through the color filtering device. The image component is for receiving the light beams from the optical assembly and generating an image. The project lens is for forming the image on a screen.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows a light path of a projector according to a preferred embodiment of the invention.

FIGS. 2A˜2D shows a linear movement of a color filtering device according to a first embodiment of the invention.

FIG. 3 shows another color filtering device of the projector according to a second embodiment of the invention.

### DETAILED DESCRIPTION OF THE INVENTION

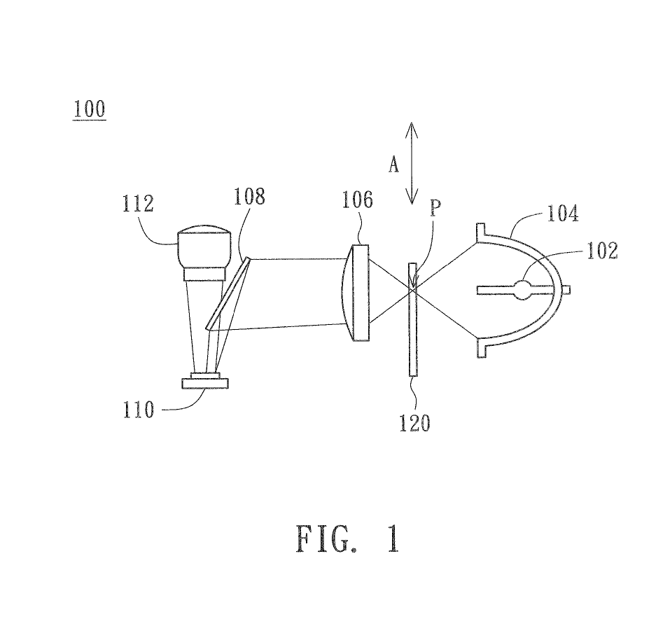

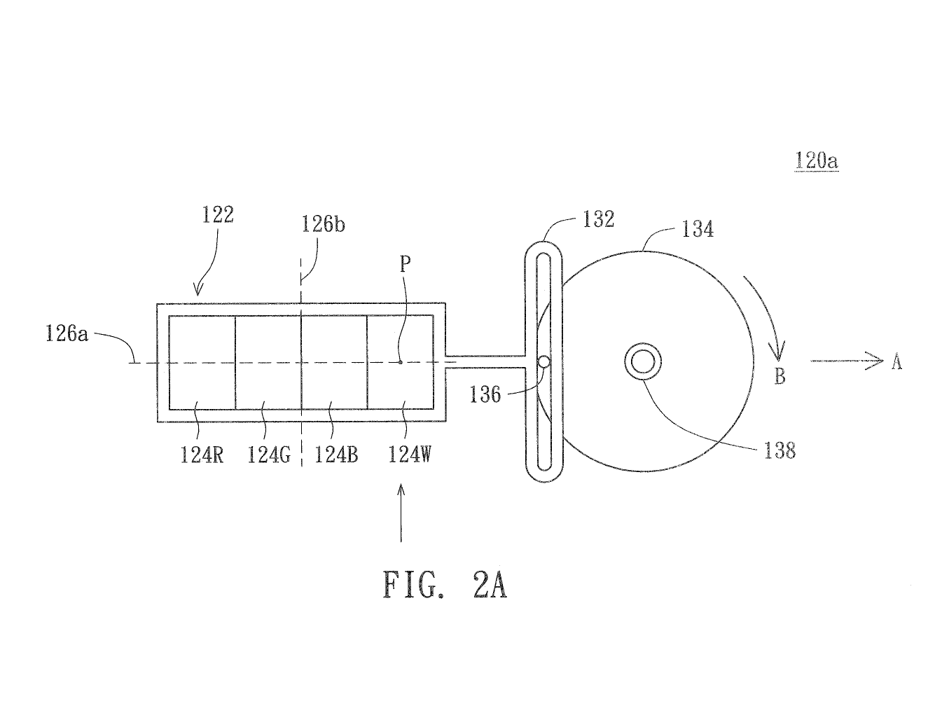

Referring to FIG. 1, a light path of a projector according to a preferred embodiment of the invention is shown. The projector 100 includes a light source 102, a color filtering device 120, an optical assembly, an imaging component 110, and a project lens 112 and preferably further includes an elliptical reflection cover 104. The light source 102, such as a light bulb, is for emitting light beams. The optical assembly is for receiving the light beams passing through the color filtering device 120. The optical assembly includes a lens module 106 and a fold mirror 108. The lens module 106 is for receiving the light beams passing through the color filtering device 120 and focusing the light beams. The fold mirror 108 is for receiving the light beams passing through the lens module 106 and changing directions of the light beams so as to project the light beams to the imaging component 110. The imaging component 110, such as a digital micromirror device (DMD), is for receiving the light beams from the optical assembly and generating an image. The project lens 112 is for forming the image on a screen. The light path of the projector as shown in FIG. 1 is that the light beams passing through the color filtering device 120 are focused by lens module 106, turned by the fold mirror 108, and projected to the imaging component 110.

Preferably, the light source 102 is disposed at a first focus point of the elliptical reflection cover 104 and the color filtering device 120 is disposed at a second focus point P of the elliptical reflection cover 104 so that the light beams reflected by the elliptical reflection cover 104 at the first focus point focus on the color filtering device 120 at the second focus point P. Thus, controlling the reciprocation movement of the color filtering device 120 can control the color filter areas through which the light beams pass. For example, the color filtering device 120 linearly moves along a first direction A and thus the light beams focus at the second focus point P fall within different areas of the color filtering device 120.

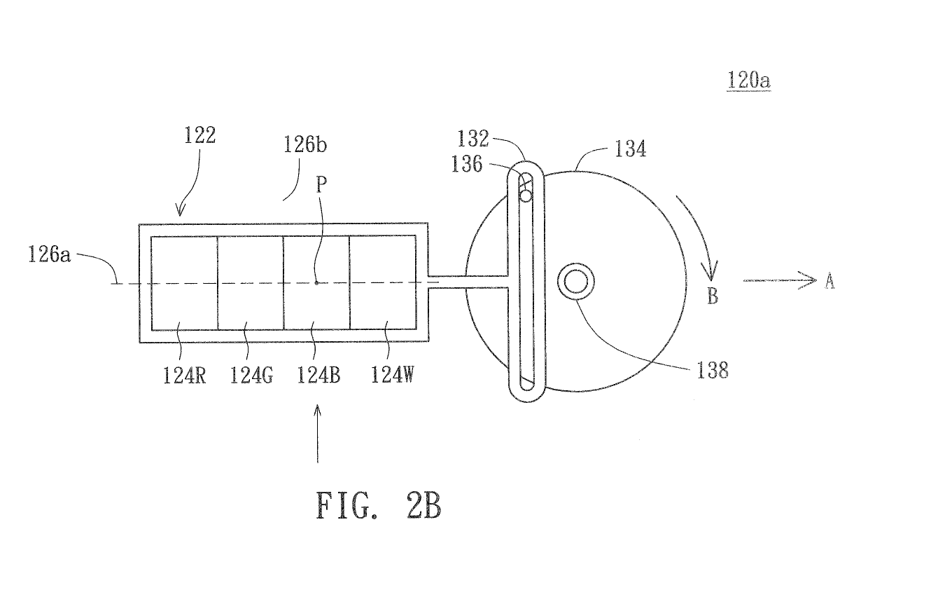

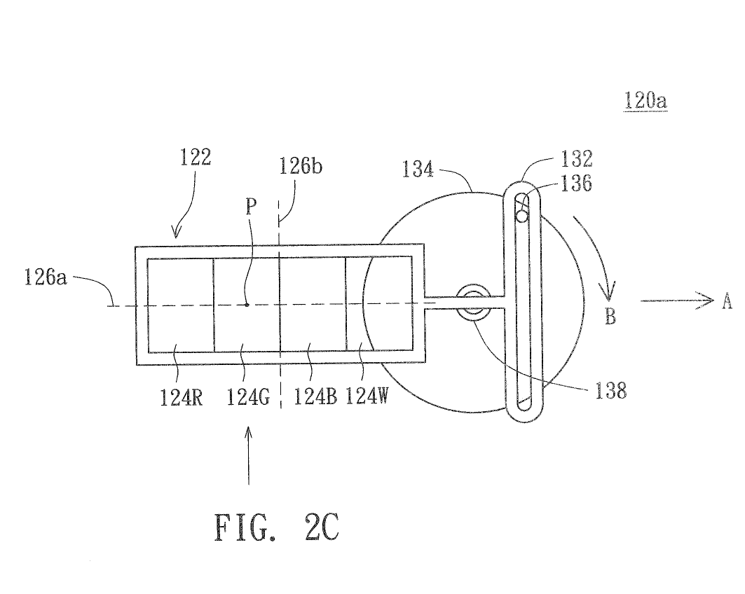

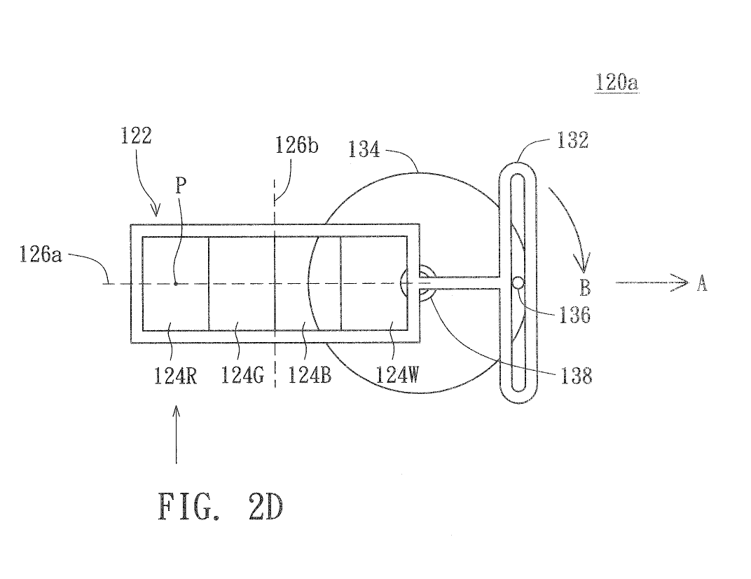

Refer to FIGS. 2A˜2D, which shows a linear movement of the color filtering device according to a first embodiment of the invention. The color filtering device 120a includes a rectangular body 122 and several color filter areas. The rectangular body 122 has a longitudinal axis 126a and a lateral axis 126b. The color filter areas having different colors are sequentially arranged along the longitudinal axis 126a on the rectangular body 122 for filtering light beams. The light beams pass the color filter areas sequentially and then present the corresponding colors of the passed color filter areas.

The color filtering device 120a including a red filter area 124R, a green filter area 124G, a blue filter area 124B, and a white filter area 124W is taken for example but not for limiting colors and the color sequence thereof. Beside, the color filtering device 120a can includes a red filter area 124R, a green filter area 124G, a blue filter area 124B arranged in any permutation or includes other color filter areas instead or added therein. Thus, the number of the color filter areas is not limited to 4 according to the invention. As shown in FIG. 2A, the red filter area 124R, green filter area 124G, blue filter area 124B and white filter area 124W are rectangles. Further, the light beams pass the color filter areas sequentially and then present the corresponding colors of the passed color filter areas. That is, light beams pass the red filter area 124R and then present red, light beams pass the green filter area 124G and then present green, light beams pass the blue filter area 124B and then present red, and light beams pass the white filter area 124W and then present white Controlling the color filter areas through which the light beams pass, the light beams are able to present red, green, blue or white so that a true color image can be generated.

Preferably, the color filtering device 120a further includes a shift mechanism. The shift mechanism can be any mechanism that reciprocates the rectangular body 122 along the longitudinal axis 126a. Preferably, the shift mechanism includes a sliding track 132 and a wheel 134. The shift mechanism can include a belt driven by a motor instead. The sliding track 132 is connected to one side of the rectangular body and extending along a direction parallel to the lateral axis 126b. As shown in FIGS. 2A˜2D, the sliding track 132 is connected to the short side of the rectangular body 122 via a rod so that the sliding track 132 is adjacent to the short side of the rectangular body 122. The wheel 134 has a protruding point 136. The protruding point 136 is slidably engaged with the sliding track 132. When the wheel 134 rotates one circle, the protruding point 136 slides along the sliding track 132 back and forth once. The wheel 134 can be positioned near the point on which the reflected light beams focus, such as the position at one side of the second focus point P of the elliptical reflection cover 104 (as shown in FIG. 1).

As shown in FIG. 2A, the protruding point 136 is at the nearest location to the second focus point P, the light beams focused on the second focus point P pass through the white filter area 124W and thus present white. When the protruding point 136 pivots on the axle 138 of the wheel 134 and rotates along the second direction B, the protruding point 136 moves away from the second focus point P and the rectangular body 122 slides along the longitudinal axis 126a, as shown in FIG. 2B. In the meantime, the light beams focused on the second focus point P pass through the white filter area 124B and thus present blue.

When the protruding point 136 continues to pivot on the axle 138 of the wheel 134 and rotate along the second direction B, the protruding point 136 moves farther away from the second focus point P and the rectangular body 122 keeps sliding along the longitudinal axis 126a, as shown in FIG. 2C. In the meantime, the light beams focused on the second focus point P pass through the green filter area 124G and thus present green.

When the protruding point 136 proceeds to pivot on the axle 138 of the wheel 134 and rotate along the second direction B, the protruding point 136 moves to the farthest location to the second focus point P, as shown in FIG. 2D. In the meantime, the light beams focused on the second focus point P pass through the red filter area 124R and thus present red.

The subsequent movement of the color filtering device may be deduced by analogy. When the protruding point 136 continues to pivot on the axle 138 of the wheel 134 and rotate along the second direction B, the protruding point 136 gradually moves from the farthest location to the nearest location as compared to the second focus point P. Hence, rotating the wheel 134 can control the reciprocation movement of the rectangular body 122 along the longitudinal axis 126a and further control the color filter areas through which the light beams pass so as to determine the presented colors of the light beams.

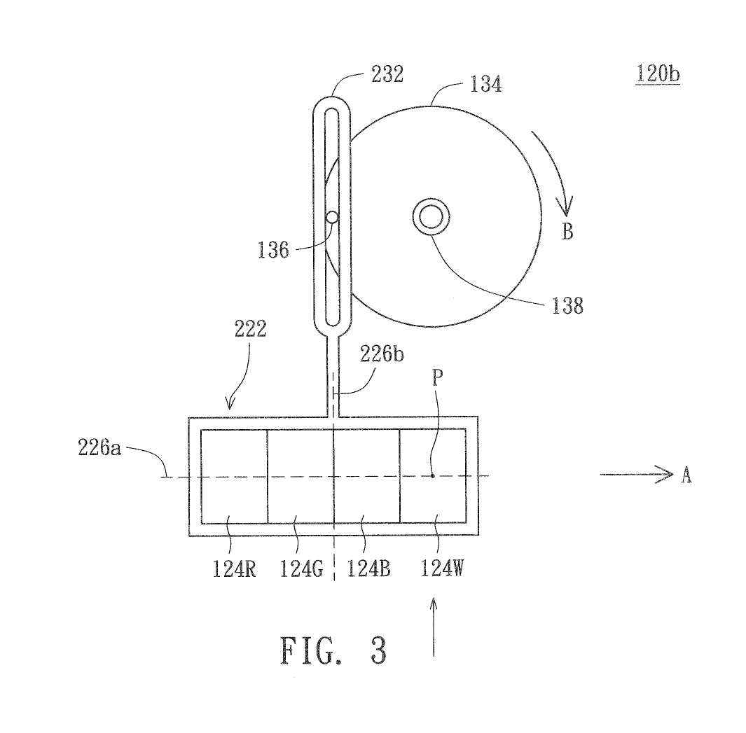

Referring to FIG. 3, another color filtering device of the projector according to a second embodiment of the invention is shown. The difference between the second and first embodiments is the sliding track 232 of the color filtering device 120b of the second embodiment is connected to the long side of the rectangular body 222 while the sliding track 132 of the first embodiment is connected to the short side of the rectangular body 122. When the protruding point 136 pivots on the axle 138 and rotates along the second direction B, the protruding point 136 slidably engaged with the sliding track reciprocates the rectangular body 222 along the longitudinal axis 126a. Hence, rotating the wheel 134 can control the color filter areas through which the light beams pass to determine the presented colors of the light beams.

The projector according to the above-mentioned embodiments includes the light source 102, elliptical reflection cover 104, color filtering device 120, optical assembly, imaging component 110, and project lens 112. However, the projector according to the invention is not limited thereto. Any color filtering device having a rectangular body and any projector using the same are within the scope of the invention.

The color filtering device according to the embodiments has the rectangular body. Therefore, the utility rate of the glass can be enhanced by cutting the rectangular glass into the rectangular body of the color filtering device during manufacturing the color filtering device. As compared with the conventional round color wheel, the color filtering device according to the invention having a rectangular body can avoid wasting a lot of glass and therefore greatly reduce the cost for manufacturing the color filtering device.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A color filtering device, comprising:
a rectangular body having a longitudinal axis and a lateral axis reciprocated along the longitudinal axis; and
a plurality of color filter areas having a plurality of different colors, sequentially arranged along the longitudinal axis on the rectangular body, for filtering light beams;
wherein the light beams pass the color filter areas sequentially and present the corresponding colors of the passed color filter areas.

2. The color filtering device according to claim 1, wherein the color filter areas are rectangular.

3. The color filtering device according to claim 2, wherein the color filter areas through which the light beams pass are controlled by means of a linear movement of the color filtering device.

4. The color filtering device according to claim 3 further comprising a shift mechanism, for reciprocating the rectangular body along the longitudinal axis.

5. The color filtering device according to claim 4, wherein the shift mechanism comprises:
a sliding track connected to one side of the rectangular body and extending along a direction parallel to the lateral axis; and
a wheel having a protruding point, the protruding point being slidably engaged with the sliding track;
wherein when the wheel rotates one circle, the protruding point slides along the sliding track back and forth once.

6. The color filtering device according to claim 1, wherein the color filter areas includes a red filter area, a green filter area, a blue filter area, and a white filter area, so that the light beams pass thereof present red, green, blue, and white respectively.

7. A projector, comprising:
a light source, for emitting light beam;
a color filtering device, comprising:
a body having a longitudinal axis and a lateral axis, wherein the body is reciprocated along the longitudinal axis; and
a plurality of color filter areas having a plurality of different colors, sequentially arranged along the longitudinal axis on the body, for filtering the light beams;
wherein the light beams pass through the color filter areas sequentially and then present the corresponding colors of the passed color filter areas;
an optical assembly, for receiving the light beams passing through the color filtering device;
an imaging component, for receiving the light beams from the optical assembly and generating an image; and
a project lens for forming the image on a screen.

8. The projector according to claim 7, wherein the color filter areas are rectangular.

9. The projector according to claim 7, wherein the color filter areas through which the light beams pass are controlled by means of a linear movement of the color filtering device.

10. The projector according to claim 8, wherein the color filtering device further comprises a shift mechanism, for reciprocating the body along the longitudinal axis.

11. The projector according to claim 9, wherein the shift mechanism comprises:
a sliding track, connected to one side of the body and extending along a direction parallel to the lateral axis; and
a wheel having a protruding point, the protruding point being slidably engaged with the sliding track;
wherein when the wheel rotates one circle, the protruding point slides along the sliding track back and forth once.

12. The projector according to claim 7, wherein the color filter areas includes a red filter area, a green filter area, a blue filter area, and a white filter area, so that the light beams pass thereof present red, green, blue, and white respectively.

13. The projector according to claim 7, wherein the optical assembly comprises:
a lens module, for receiving the light beams passing through the color filtering device and focusing the light beams; and
a fold mirror, for receiving the light beams passing through the lens module and changing directions of the light beams so as to project the light beams to the imaging component.

14. The projector according to claim 7, wherein the imaging component is a digital micromirror device (DMD).
